(19) United States
(12) Patent Application Publication
(10) Pub. No.: US 2016/0102499 A1
(43) Pub. Date: Apr. 14, 2016

(54) Improved Turbine

(71) Applicant: ROTECH GROUP LIMITED, Aberdeenshire (GB)

(72) Inventors: Kenneth Roderick Stewart, Aberdeen, Aberdeenshire (GB); Donald Stewart, Near Inverness, Highland (GB)

(21) Appl. No.: 14/786,796

(22) PCT Filed: Apr. 25, 2014
(86) PCT No.: PCT/GB2014/051303

§ 371 Date: Oct. 23, 2015

(30) Foreign Application Priority Data
Apr. 26, 2013 (GB) 1307558.5

(51) Int. Cl. E21B 4/02; E21B 3/00; F03B 13/02

(52) U.S. Cl. CPC E21B 4/02; F03B 13/02; E21B 3/00

(57) ABSTRACT

An improved turbine or motor, such as a fluid or liquid driven turbine or motor or hydraulic turbine or motor including a downhole turbine for the oil/gas and geothermal industries, such as a drilling turbine or downhole drilling turbine. The turbine or motor provides a fluid passage comprising at least one portion or zone arranged to cause a drive fluid to be moved or diverted, such as at least partly radially. The turbine or motor may comprise a rotor having a rotor blade extending within the fluid passage. The turbine or motor may comprise a stator having a stator blade extending within the fluid passage. The stator (30) may comprise or define at least part of the at least one portion or zone configured or arranged to cause the fluid to be moved in or diverted from an at least part axial path to an at least part radial path or radially inward path.

### FIELD OF INVENTION

The present invention relates to an improved turbine or motor, such as a fluid or liquid driven turbine or motor or hydraulic turbine or motor. The present invention particularly, though not exclusively relates to an improved downhole turbine which may find use in the oil/gas and geothermal industries, e.g. as a drilling turbine or downhole drilling turbine.

### BACKGROUND TO INVENTION

Drilling turbines are known. In known downhole turbines used for well drilling operations in the oil and/or gas and/or geothermal arts/markets, a flow path of fluid through the turbine is generally axial in direction. The flow passes through multiple stages of axial stator and rotor blades. During such passage a given streamline of flow, while changing circumferential position by virtue of being diverted by the stator and rotor blades, will approximately maintain a radial position. In other words, the fluid does not flow radially from a centre of the turbine towards an outside of the turbine or vice versa. As with any turbine, fluid energy is converted into mechanical energy, such as torque on the turbine shaft, via conservation of angular momentum. In known downhole turbines each stage generates only a relatively small change in angular momentum via the circumferential deflection of the fluid. This has benefit in that when unloaded, the turbine's runaway speed is not vastly greater than the turbine's designed loaded speed. However, it has a disadvantage that a large number of stages are required in order to generate a useful amount of torque for drilling operations. Thus, known downhole turbines tend to be very long compared to non-turbine downhole motors. This is disadvantageous for drilling operations. Also, if the turbine fails during operation, complex and lengthy fishing operations are often required to remove the many individual components or stages that are in the well.

An example of an alternative radial drilling turbine is disclosed in WO 00/08293 (ROTECH HOLDINGS LIMITED), the content of which is incorporated herein by reference. Therein, the drilling turbine comprises a tubular casing enclosing a chamber having rotatably mounted therein a rotor. The rotor comprises at least one turbine wheel with an annular array of angularly distributed blades. The blades are orientated with drive fluid receiving faces thereof facing generally rearwardly of a forward direction of rotation of the rotor, and a generally axially extending inner drive fluid passage means generally radially inwardly of said rotor. The casing also has generally axially extending outer drive fluid passage means, and one of the inner and the outer drive fluid passages are provided with outlet nozzle means formed and arranged for directing at least one jet of drive fluid onto the blade drive fluid receiving faces as the blades transverse the nozzle means for imparting rotary drive to said rotor. The other of the inner and the outer drive fluid passages is provided with exhaust aperture means for exhausting drive fluid from the turbine. A radial turbine for a drilling application however is less efficient at higher flow rates.

GB 866,670 (W. Tiraspolsky) relates to a well-drilling turbine comprising a rotor built up of a stack of parts and an outer stator also built up of a stack of parts, at least one of the stacks of parts being held together by a set of tension members passed through apertures or notches in the parts and pre-stressing the parts in compression.

It is an object of at least one embodiment of at least one aspect of the present invention to obviate or at least mitigate one or more problems/disadvantages in the prior art.

It is an object of at least one embodiment of at least one aspect of the present invention to provide a turbine having improved/increased output torque per stage than known turbines.

It is an object of at least one embodiment of at least one aspect of the present invention to provide a turbine having greater output power and/or torque extraction per turbine stage than in the prior art.

It is an object of at least one embodiment of at least one aspect of the present invention to provide a turbine which is generally shorter than known turbines.

### SUMMARY OF INVENTION

According to the present invention there is provided a general solution of a turbine or motor, such as a downhole turbine or motor, wherein there is provided a fluid passage comprising at least one portion or zone arranged to cause a fluid to be moved or diverted, e.g. at least partly radially.

The turbine may comprise a rotor comprising at least one rotor blade. The at least one rotor blade may be positioned in or extend within the fluid passage.

The turbine may comprise a stator comprising at least one stator blade. The at least one stator blade may be positioned in or extend within the fluid passage.

The stator (or stator blade) may comprise or define at least part of the at least one portion or zone configured or arranged to cause the fluid to be moved in or diverted from an at least part axial path to an at least part radial path or radially inward path.

The rotor (or rotor blade) may comprise or define at least part of the at least one portion or zone configured or arranged to cause the fluid to be moved in or diverted from an at least part radial path or radially inward path to an at least part axial path.

The fluid may comprise a turbine or motor drive fluid. The fluid may enter and/or exit the turbine in an axial direction. The turbine or motor may comprise a fluid, e.g. liquid, driven turbine or motor, e.g. a hydraulic turbine or motor. The turbine or motor may convert drive fluid energy to mechanical energy, thereby generating output torque from the turbine or motor.

The fluid passage may be a substantially annular or ring shaped fluid passage.

A diverted path of the fluid may comprise a radial part and a circumferential part.

A path prior to diversion may comprise an axial part and a circumferential part.

Such diverted path or such at least part radial movement or diversion may cause a change, e.g. an increased or greater change, in the angular momentum of the fluid. Prior to the at least part radial diversion the angular momentum of the fluid may be greater than the angular momentum of the fluid following or subsequent the at least part radial diversion of the fluid. The at least part radial diversion may cause a decrease in the angular momentum of the fluid. Such change in angular momentum may beneficially create or produce output torque from the turbine. By providing an increased or greater change in the angular momentum of the fluid, conversion of fluid energy to mechanical energy, e.g. generating output torque from the turbine or motor, may be increased or enhanced.

Angular momentum of the fluid may be transferred to the turbine, e.g. rotor(s) of the turbine, e.g. rotor blade(s) of the turbine, thus generating torque.

The at least partly radial directional flow or diversion may allow angular momentum to be removed from the fluid in a shorter axial distance than in the prior art.

The radial movement or diversion may be radially inward. The radial movement or diversion may occur over a portion of at least one blade of a stator and/or rotor of the turbine.

The/each rotor may be arranged so as to transfer energy of motion of the fluid to an output means of the turbine.

The at least one portion or zone of the fluid passage may cause the fluid to be moved in or diverted to a radial path, e.g. radially inward path, from a substantially axial path.

The turbine may comprise a plurality of stages.

A/each stage may comprise (e.g. longitudinally comprise) a stator, a/the rotor, a passage (e.g. a rotor passage and a stator passage), each of which may be in fluid communication with one another.

A passage or stator passage of one stage may be adjacent and may be in fluid communication with a rotor passage of a next stage.

The radial diversion may occur over a portion of a/the passage or stator passage.

The turbine may comprise a plurality of stages, e.g. 3 to 9, e.g. 5 or 7.

The rotor may comprise at least one, and preferably a plurality of circumferentially disposed rotor blades, e.g. on a rotor hub, e.g. integrally formed with the rotor hub.

The stator may comprise at least one, and preferably a plurality of circumferentially disposed stator blades, e.g. on a stator hub, e.g. integrally formed with the stator hub.

The passage/passages may be annular or ring shaped.

Preferably an (outer) rotor shroud may be provided (circumferentially) adjacent an outer edge(s) of rotor blade(s) of a/each rotor.

Preferably an (outer) stator shroud may be provided (circumferentially) adjacent an outer edge(s) of stator blade(s) of a/each stator.

The/each rotor may be arranged so as to rotate with an output means, e.g. output shaft of the turbine.

The/each rotor may be keyed to the output shaft.

The fluid passage may comprise at least one further portion or zone arranged to cause a/the fluid to be further diverted radially.

The further radial diversion may be radially outward.

The further radial diversion may occur over a portion of a/the passage or rotor passage.

In one implementation the rotor shroud may be stationary, while in another the rotor shroud may rotate with the rotor blade(s) and rotor hub. In one implementation the rotor shroud may be formed separately from the rotor blade(s) and rotor hub. In such case there may be a gap between the rotor shroud and tip(s) of the rotor blade(s), e.g. so as to allow rotation of the rotor hub. In another implementation the rotor shroud may be formed integrally with or joined with the rotor blade(s) and rotor hub. In one implementation the stator shroud may be formed separately from stator blade(s) and stator hub. In another implementation the stator shroud may be formed integrally with or joined with the stator blade(s) and stator hub.

According to a first aspect of the present invention there is provided a turbine, such as a downhole turbine, comprising at least one blade, wherein the at least one blade comprises a fluid inlet end and a fluid outlet end, the fluid inlet end being disposed radially outward and axially upstream of the fluid outlet end.

The at least one blade may comprise an at least one first blade or rotor blade or form part of a rotor.

The rotor may be disposed to rotate around a longitudinal axis of the turbine. The rotor may comprise a hub which may carry the first/rotor blade(s) peripherally/circumferentially thereupon.

The at least one blade may comprise an at least one second blade or stator blade or form part of a stator.

The stator may be disposed around a longitudinal axis of the turbine. The stator may comprise a stator hub which may carry the second/stator blade(s) peripherally/circumferentially thereupon.

According to a second aspect of the present invention there is provided a turbine, such as a downhole turbine, comprising at least one blade, wherein the at least one blade comprises a leading (upstream) edge and a trailing (downstream) edge, the leading edge being disposed radially outward of the trailing edge.

The at least one blade may comprise an at least one first blade or rotor blade or form part of a rotor.

The rotor may be disposed to rotate around a longitudinal axis of the turbine.

The rotor may comprise a hub which may carry the first/rotor blade(s) peripherally/circumferentially thereupon.

The at least one blade may comprise an at least one second blade or stator blade or form part of a stator.

The stator may be disposed around a longitudinal axis of the turbine.

The stator may comprise a stator hub which may carry the second/stator blade(s) peripherally/circumferentially thereupon.

According to a third aspect of the present invention there is provided a turbine, such as a downhole turbine, comprising at least one rotor wherein the at least one rotor comprises at least one blade arranged or configured to impart axial motion to a turbine drive fluid, in use.

A leading or first portion of the at least one rotor blade may be arranged or configured to convert a/the motion of the turbine drive fluid from a substantially radial such as radially inward, (e.g. radial and circumferential) motion to a substantially axial (e.g. axial and circumferential) motion.

The substantially radial motion may be a radial inward motion.

A trailing or second portion of the at least one rotor blade may be arranged or configured to cause the turbine drive fluid to leave or exit (or alternatively arrive or enter) the at least one rotor blade with a substantially axial motion.

According to a fourth aspect of the present invention there is provided a turbine, such as a downhole turbine, comprising at least one stator wherein the at least one stator comprises at least one blade arranged or configured to impart radial motion to a turbine drive fluid, in use.

The at least one stator blade may be arranged or configured to convert a/the motion of the turbine drive fluid from a substantially axial (e.g. axial and circumferential) motion to a substantially radial (e.g. radially inward; radial and circumferential) motion.

According to a fifth aspect of the present invention there is provided a turbine, such as a downhole turbine, comprising at least one rotor, wherein the at least one rotor comprises at least one blade to form at least one rotor blade passage arranged or configured to impart axial motion to a turbine drive fluid, in use. The rotor blade passage may be a portion of the fluid passage into which at least part of the at least one rotor blade may extend or be positioned in.

A leading or first portion of the at least one rotor blade passage may be arranged or configured to convert a/the motion of the turbine drive fluid from a substantially or at least part radial, such as radially inward (e.g. radial and circumferential) motion to a substantially or at least part axial (e.g. axial and circumferential) motion.

The substantially radial motion may be radial inward motion.

A trailing or second portion of the at least one rotor blade passage may be arranged or configured to cause the turbine drive fluid to leave or exit the at least one blade with a substantially axial motion.

According to a sixth aspect of the present invention there is provided a turbine, such as a downhole turbine, comprising at least one stator, wherein the at least one stator comprises at least one blade to form at least one stator blade passage arranged or configured to impart radial motion to a turbine drive fluid, in use.

The stator blade passage may be a portion of the fluid passage into which at least part of the at least one stator blade may extend or be positioned in.

The at least one stator blade passage may be arranged or configured to convert a/the motion of the turbine drive fluid from a substantially or at least part axial (e.g. axial and circumferential) motion to a substantially or at least part radial, such as radially inward (e.g. radial and circumferential or radial, axial and circumferential) motion.

According to a seventh aspect of the present invention there is provided a turbine, such as a downhole turbine, comprising at least one rotor, wherein the at least one rotor comprises at least one rotor blade arranged or configured to impart radial motion to a turbine drive fluid, in use.

A leading or first portion of the at least one rotor blade may be arranged or configured to convert a/the motion of the turbine drive fluid from a substantially or at least part axial (e.g. axial and circumferential) motion to a substantially or at least part radial, such as radially inward (e.g. radial and circumferential) motion.

The substantially radial motion may be radial inward motion.

A trailing or second portion of the at least one rotor blade may be arranged or configured to cause the turbine drive fluid to leave or exit the at least one rotor blade with a substantially or at least part radial motion.

According to an eighth aspect of the present invention there is provided a turbine, such as a downhole turbine, comprising at least one stator, wherein the at least one stator comprises at least one stator blade arranged or configured to impart axial and circumferential motion to a turbine drive fluid, in use.

The at least one stator blade may be arranged or configured to convert a/the motion of the turbine drive fluid from a substantially or at least part radial, such as radially outward (e.g. radially and circumferential) motion to a substantially or at least part axial (e.g. axial and circumferential) motion.

According to a ninth aspect of the present invention there is provided a turbine, such as a downhole turbine, comprising at least one rotor, wherein the at least one rotor comprises at least one rotor blade to form at least one blade passage arranged or configured to impart radial motion to a turbine drive fluid, in use. The rotor blade passage may be a portion of the fluid passage into which at least part of the at least one rotor blade may extend or be positioned in.

A leading or first portion of the at least one rotor blade passage may be arranged or configured to convert a/the motion of the turbine drive fluid from a substantially or at least part axial (e.g. axial and circumferential) motion to a substantially or at least part radial, such as radially inward (e.g. radial and circumferential) motion.

The substantially radial motion may be radial inward motion.

A trailing or second portion of the at least one rotor blade passage may be arranged or configured to cause the turbine drive fluid to leave or exit the at least one rotor blade with a substantially or at least part radial motion.

According to a tenth aspect of the present invention there is provided a turbine, such as a downhole turbine, comprising at least one stator, wherein the at least one stator comprises at least one stator blade to form at least one blade passage arranged or configured to impart axial and circumferential motion to a turbine drive fluid, in use. The stator blade passage may be a portion of the fluid passage into which at least part of the at least one stator blade may extend or be positioned in.

The at least one stator blade passage may be arranged or configured to convert a/the motion of the turbine drive fluid from a substantially or at least part radial, such as radially outward (e.g. radially and circumferential) motion to a substantially or at least part axial (e.g. axial and circumferential) motion.

According to an eleventh aspect of the present invention there is provided a turbine, such as a downhole turbine, comprising at least one rotor wherein the at least one rotor comprises at least one blade arranged or configured to impart radial motion to a turbine drive fluid, in use.

A leading or first portion of the at least one rotor blade may be arranged or configured to convert a/the motion of the turbine drive fluid from a substantially radial such as radially inward, (e.g. radial and circumferential) motion to a substantially or at least part axial (e.g. axial and circumferential) motion.

The substantially radial motion may be a radial inward motion.

A trailing or second portion of the at least one rotor blade may be arranged or configured to convert a/the motion of the turbine drive fluid from a substantially or at least part axial (e.g. axial and circumferential) motion to a substantially radial, such as radially outward, (e.g. radial and circumferential) motion.

According to a twelfth aspect of the present invention there is provided a turbine, such as a downhole turbine, comprising at least one stator wherein the at least one stator comprises at least one blade arranged or configured to impart radial motion to a turbine drive fluid, in use.

The at least one stator blade may be arranged or configured to convert a/the motion of the turbine drive fluid from a substantially radial (e.g. radially outward; radial and circumferential) motion to a substantially radial (e.g. radially inward; radial and circumferential) motion.

A leading or first portion of the at least one stator blade may be arranged or configured to convert a/the motion of the turbine drive fluid from a substantially radial such as radially outward, (e.g. radial and circumferential) motion to a substantially or at least part axial (e.g. axial and circumferential) motion.

The substantially radial motion may be a radial outward motion.

A trailing or second portion of the at least one stator blade may be arranged or configured to convert a/the motion of the turbine drive fluid from a substantially or at least part axial (e.g. axial and circumferential) motion to a substantially radial, such as radially inward, (e.g. radial and circumferential) motion.

According to a thirteenth aspect of the present invention there is provided a turbine, such as a downhole turbine, comprising at least one rotor, wherein the at least one rotor comprises at least one blade to form at least one rotor blade passage arranged or configured to impart radial motion to a turbine drive fluid, in use. The rotor blade passage may be a portion of the fluid passage into which at least part of the at least one rotor blade may extend or be positioned in.

A leading or first portion of the at least one rotor blade passage may be arranged or configured to convert a/the motion of the turbine drive fluid from a substantially or at least part radial, such as radially inward (e.g. radial and circumferential) motion to a substantially or at least part axial (e.g. axial and circumferential) motion.

The substantially radial motion may be radial inward motion.

A trailing or second portion of the at least one rotor blade passage may be arranged or configured to convert a/the motion of the turbine drive fluid from a substantially or at least part axial (e.g. axial and circumferential) motion to a substantially or at least part radial, such as radially outward (e.g. radial and circumferential) motion.

According to a fourteenth aspect of the present invention there is provided a turbine, such as a downhole turbine, comprising at least one stator, wherein the at least one stator comprises at least one blade to form at least one stator blade passage arranged or configured to impart radial motion to a turbine drive fluid, in use. The stator blade passage may be a portion of the fluid passage into which at least part of the at least one stator blade may extend or be positioned in.

A leading or first portion of the at least one stator blade passage may be arranged or configured to convert a/the motion of the turbine drive fluid from a substantially or at least part radial such as radially outward, (e.g. radial and circumferential) motion to a substantially or at least part axial (e.g. axial and circumferential) motion.

The substantially radial motion may be a radial outward motion.

A trailing or second portion of the at least one stator blade passage may be arranged or configured to convert a/the motion of the turbine drive fluid from a substantially or at least part axial (e.g. axial and circumferential) motion to a substantially radial, such as radially inward, (e.g. radial and circumferential) motion. Features of the foregoing general solution or aspects of the present invention may be provided singly or in combination.

Preferably the turbine may be a fluid driven turbine, e.g. a liquid driven turbine. The turbine may be a downhole turbine, e.g. a downhole drilling turbine. The turbine may be a hydraulic turbine.

The aforementioned fluid may comprise a turbine drive fluid.

The stator(s) and/or rotors(s) may be provided within a tubular housing. The stator (stator hubs) may be mounted in fixed relation to a/the tubular housing. The rotor(s) (rotor hubs) may be mounted in fixed relation to a rotatable shaft, e.g. drive shaft. A bit box may be mounted on or rotationally in fixed relation relative to the shaft.

A rotor exit passage may cause the motion of turbine drive fluid to convert from the substantially axial motion to a substantially radial (e.g. radially outward) motion. Alternatively or additionally, the rotor exit passage may cause the turbine drive fluid to be moved or diverted substantially or at least part radially (e.g. radially outward).

The rotor exit passage may be substantially annular or ring shaped.

A stator inlet passage may cause the motion of turbine drive fluid to convert from a radial (e.g. radially outward) motion to a substantially axial (e.g. axial and circumferential) motion. Alternatively or additionally, the stator inlet passage may cause the turbine drive fluid to be moved or diverted, e.g. moved or diverted, substantially radially (e.g. radially outwards) and/or substantially or at least partially axially.

The stator inlet passage may be substantially annular or ring shaped.

An outlet end of the rotor passage may be in fluid communication with an inlet end of the stator inlet passage.

An outlet end of the/a stator may be in fluid communication with an inlet end of the/a rotor.

Preferably the turbine may comprise a plurality of (stacked) stator and rotor pairs. Preferably the stator and rotor stack may have a stator furthest uphole or upstream, i.e. closest to surface.

Beneficially for each stator/rotor pair, the number of rotor blades may be less than the number of stator blades.

Preferably the/each rotor may comprise a plurality of circumferentially disposed rotor blades, e.g. between 8 and 16, e.g. beneficially 11 or 13 blades.

Beneficially for the/each rotor blade:
a leading edge angle from a radial direction at the leading edge (LE) hub may be between 25° and 50°, e.g. 35°; and/or

a leading edge (LE) angle from a radial direction at the leading edge shroud may be between 30° and 55°, e.g. 48°; and/or a

trailing edge (TE) angle from an axial direction at the trailing edge hub may be between −20° and −29°, e.g. −25°; and/or

a trailing edge angle from an axial direction at the trailing edge shroud may be between −20° and −50°, e.g. −45°.

Beneficially for the/each rotor blade:

the rotor blade thickness near the leading edge may be between 2 mm and 8 mm, e.g. 3 mm or 5 mm; and/or

the rotor blade thickness near the trailing edge may be between 0.25 mm and 2 mm, e.g. 1 mm or 1.5 mm.

Preferably the/each stator may comprise a plurality of circumferentially disposed blades, e.g. between 14 and 24, e.g. beneficially 17 or 21 or 19.

Beneficially for the/each stator blade:

a leading edge angle from an axial direction at the leading edge hub and/or leading edge shroud may be between −5° and 5°, e.g. 0°; and/or

a trailing edge angle from a radial direction at the trailing edge hub and/or

trailing edge shroud may be between 65° and 80°, e.g. 70° or 69°. Beneficially for the/each stator blade:

the stator blade thickness near the leading edge may be between 3 mm and 5 mm, e.g. 4 mm; and/or

the stator blade thickness near the trailing edge may be between 0.5 mm and 2 mm, e.g. 1 mm.

The turbine may comprise a power section comprising the at least one blade.

The turbine may comprise a power section comprising at least one rotor and/or stator.

According to a fifteenth aspect of the present invention there is provided a turbine assembly comprising a turbine according to any of the first to fourteenth aspects of the present invention.

The turbine assembly may comprise one or more of:

a governor, optionally above a/the turbine or power section;

an upper bearing means or pack, optionally between the governor and the turbine or power section;

a lower bearing means or pack, optionally below the turbine or power section, e.g. to absorb the thrust from the power section;

optionally, further or additional turbines or power sections and lower bearing means or pack to absorb the thrust from each additional power section;

a gear mechanism, optionally below the turbine or power section;

a further lower bearing means or pack, optionally below the gear mechanism, e.g. to absorb the axial load of from a bit box; and/or

the bit box, beneficially below the further lower bearing means or pack.

Beneficially the bit box may be capable of releasably retaining a drill bit.

According to a sixteenth aspect of the present invention there is provided a rotor for use in a turbine, such as a downhole turbine, the rotor comprising at least one blade, wherein the at least one blade comprises a fluid inlet end and a fluid outlet end, the fluid inlet end being disposed radially outward and axially upstream of the fluid outlet end.

According to a seventeenth aspect of the present invention there is provided a rotor for use in a turbine, such as a downhole turbine, the rotor comprising at least one blade, wherein the at least one blade comprises a leading (upstream) edge and a trailing (downstream) edge, the leading edge being disposed radially outward of the trailing edge.

According to a eighteenth aspect of the present invention there is provided a stator for use in a turbine, such as a downhole turbine, the stator comprising at least one blade, wherein the at least one blade comprises a fluid inlet end and a fluid outlet end, the fluid inlet end being dispersed radially outward and axially upstream of the fluid outlet end.

According to an nineteenth aspect of the present invention there is provided a stator for use in a turbine, such as a downhole turbine, the stator comprising at least one blade, wherein the at least one blade comprises a leading (upstream) edge and a trailing (downstream) edge, the leading edge being disposed radially outward of the trailing edge.

According to a twentieth aspect of the present invention there is provided a rotor for use in a turbine, such as a downhole turbine, wherein the rotor comprises at least one blade to form at least one blade passage arranged or configured to impart radial motion (or axial motion) to a turbine drive fluid, in use.

According to a twenty first aspect of the present invention there is provided a stator for use in a turbine, such as a downhole turbine, wherein the stator comprises at least one blade to form at least one blade passage arranged or configured to impart axial motion (or radial motion) to a turbine drive fluid, in use.

According to a twenty second aspect of the present invention there is provided a method of drilling a borehole, such as an oil or gas well, the method comprising:
providing a drill string comprising a turbine according to the first to sixth aspects of the present invention;

drilling the borehole.

The drill string may provide a drill bit, e.g. at a downhole/downstream end thereof.

Drilling the borehole may comprise (rotationally) driving the drill bit by the turbine.

According to a twenty third aspect of the present invention there is provided a rotor and/or stator adapted for use in a turbine or motor, such as a downhole turbine or motor, wherein the rotor and/or stator is at least partly made from or (substantially) comprises a ceramic material.

Beneficially the rotor and/or stator is/are substantially made from or substantially comprises Tungsten Carbide.

According to a twenty fourth aspect of the present invention there is provided a turbine or motor, such as a downhole turbine or motor, comprising at least one rotor and/or stator according to the fifteenth aspect of the present invention.

The/each rotor and/or stator may be manufactured by a machining technique.

According to a twenty fifth aspect of the present invention there is provided a turbine or motor, such as a downhole turbine or motor, wherein there is provided at least one chamber between at least a portion of at least one rotor and at least a portion of an at least one stator.

The at least one chamber may comprise a plurality of chambers.

Each chamber may be at least partially circumferentially extending around the turbine or motor.

The plurality of chambers may be substantially longitudinally spaced one from the other.

The at least a portion of the/each at least one rotor may comprise at least one/a respective rotor shroud.

The at least a portion of the/each at least one stator may comprise at least one/a respective stator hub and/or at least one/a respective stator shroud.

The at least one/each chamber may, in use, act as a vibration damping chamber.

At a/each longitudinal end of the/each chamber may be provided a seal, e.g. a liquid seal. The seal may, in use, act as a vibration damping chamber seal.

A seal may be provided between adjacent chambers.

Any of the aforementioned general solutions or aspects of the present invention may be combined. Alternatively, or additionally, any of the aforementioned features, e.g. optional or preferable, features of any of the aforementioned general solutions or aspects of the present invention may find separate utility in any of the other general solutions or aspects of the present invention.

### BRIEF DESCRIPTION OF DRAWINGS

An embodiment of the present invention will now be described, by way of example only, and with reference to the accompanying drawings, which are:

FIGS. 1(a) to (d) cross-sectional side views of:
(a) an uphole or topmost part of a turbine assembly comprising a turbine according to a first embodiment of the present invention;
(b) a further part of the turbine assembly of FIG. 1(a);
(c) a yet further part of the turbine of FIG. 1(a); and
(d) a downhole or bottom-most part of the turbine assembly of FIG. 1(a);

FIG. 2 a cross-sectional side view to an enlarged scale of part of a turbine comprising a plurality of first rotors and stators of the further part of the turbine assembly of FIGS. 1(a) to (d);

FIG. 3 a cross-sectional top view to an enlarged scale of a first rotor and first stator of FIG. 2;

FIG. 4 a perspective view from a side and below of a second rotor suitable for use in the turbine of FIGS. 1(a) to (d);

FIGS. 5(a) and (b) perspective views from a side and below of:
(a) a top-most portion of the second rotor of FIG. 4; and
(b) a bottom-most portion of the second rotor of FIG. 4;

FIG. 6 a perspective view from a side and above of a second stator suitable for use in the turbine of FIGS. 1(a) to (d);

FIG. 7 a perspective view from a side and above of a third stator suitable for use in the turbine of FIGS. 1(a) to (d);

FIGS. 8(a) and (b) perspective views of a fourth stator suitable for use in the turbine of FIGS. 1(a) to (d):
(a) from a side and above; and
(b) from a side and below;

FIGS. 9(a) to (b) perspective views from a side and above of:
(a) a further rotor suitable for use in the turbine of FIGS. 1(a) to (d); and
(b) a further stator suitable for use in the turbine of FIGS. 1(a) to (d);

FIG. 9 (c) a cross-sectional side view of part of a rotor/stator stack comprising rotors and stators according to FIGS. 9(a) and (b), respectively; and

FIG. 10 a cross-sectional side view to an enlarged scale of part of another arrangement of the turbine of FIG. 2.

### DETAILED DESCRIPTION OF DRAWINGS

An embodiment of the present invention will now be described with reference to the accompanying drawings. Referring initially to FIGS. 1(a) to 3, there is shown a turbine assembly 35 comprising a turbine (or motor), generally designated 5, according to a first embodiment of the present invention.

The turbine 5 comprises a power section 10 comprising a plurality of rotor blades 15 and stator blades 20. The turbine 5 comprises the power section 10 comprising a plurality of rotors 25 and stators 30 carrying the respective rotor blades 15 and stator blades 20.

The turbine 5 comprises part of a turbine assembly 35. The turbine assembly 35 comprises one or more of:

a governor 40 provided above the turbine 5 or power section 10;

an upper bearing means or pack 41 provided between the governor 40 and the turbine 5 or power section 10;

a lower bearing means 42 below the power section 10, such lower bearing means 42 may optionally be combined in the same housing as the gear mechanism 45;

a gear mechanism 45 provided below the turbine 5 or power section 10; a further lower bearing means or pack 50 provided below the gear mechanism 45; and

a drive shaft 54 and bit box 55 for a drill bit, the bit box 55 being provided below the further lower bearing means or pack 50.

In this embodiment the turbine 5 is a downhole turbine comprising at least one rotor/stator blade 15,20, wherein the at least one blade 15,20 comprises a fluid inlet end and a fluid outlet end, the fluid inlet end being disposed radially outward and axially upstream of the fluid outlet end.

The at least one rotor blade 15 comprises an at least one first blade forming part of the rotor 25. The rotor 25 is disposed to rotate around a longitudinal axis A of the turbine 5. The rotor 25 comprises a rotor hub 60 which carries the rotor blade 15 peripherally/circumferentially thereupon.

The at least one stator blade 20 comprises an at least one second blade forming part of a stator 30. The stator 30 is disposed around the longitudinal axis A of the turbine 5. The stator 30 comprises a stator hub 65 which carries the stator blade 20 peripherally/circumferentially thereupon.

The turbine 5 comprises at least one rotor/stator blade 15,20, wherein the/each at least one rotor/stator blade 15,20 comprises a respective leading (upstream) edge 70,75 and a respective trailing (downstream) edge 80,85, the leading edge(s) 70,75 being disposed radially outward of the respective trailing edge 80,85.

The turbine 5 comprises at least one rotor 25 wherein the at least one rotor 25 comprises at least one rotor blade 15 to form at least one blade passage arranged or configured to impart axial motion to a turbine drive fluid, in use.

A leading or first portion of each/the at least one rotor blade (passage) 15 is arranged or configured to convert a/the motion of the turbine drive fluid from a substantially or at least part radial (e.g. radially inward; radial and circumferential) motion to a substantially or at least part axial (e.g. axial and circumferential) motion. The substantially radial motion is a radial inward motion.

A trailing or second portion of the at least one rotor blade (passage) 15 is arranged or configured to cause the turbine drive fluid to leave or exit the at least one rotor 25 with a substantially axial motion.

The turbine 5 comprises at least one stator 30 wherein the at least one stator 30 comprises at least one stator blade 20 to form at least one blade passage arranged or configured to impart radial motion to a turbine drive fluid, in use.

Each/the at least one stator blade (passage) 20 is arranged or configured to convert a/the motion of the turbine drive fluid from a substantially or at least part axial (e.g. axial and circumferential) motion to a substantially or at least part radial (e.g. radially inward; radial and circumferential) motion.

The aforementioned fluid comprises a turbine drive fluid.

The stators 30 and rotors 25 are provided within a tubular housing 90. Each stator 30 is mounted in fixed relation to tubular housing 90. The rotors 25 are mounted in fixed relation to a rotatable shaft 95, e.g. drive shaft, which is disposed upon the longitudinal axis A of the turbine 5 within the housing 90. A bit box 55 is mounted on or rotationally in fixed relation relative to the shaft 95.

A rotor exit passage 96 is configured to cause the motion of turbine drive fluid to convert from the substantially or at least part axial motion to a substantially or at least part radial (e.g. radially outward) motion. In this embodiment the rotor exit passage 96 is substantially annular or ring shaped.

A stator inlet passage 97 is configured to cause the motion of turbine drive fluid to convert from the substantially or at least part radial (e.g. radially outward) motion to a substantially or at least part axial (e.g. axial and circumferential) motion. In this embodiment the stator inlet passage is substantially annular or ring shaped. An (outer) rotor shroud member(s) 98 is/are provided circumferentially adjacent an outer edge(s) of the rotor blade(s) 15. An (inner) stator hub member 65 is/are provided adjacent inner edges of the stator blade(s) 20.

An outlet end of the stator inlet passage 97 is in fluid communication with an inlet end of a/the rotor inlet passage. An outlet end of a stator 30 is in fluid communication with an inlet end of a respective rotor 25. An outer rotor shroud member(s) 98 is/are provided circumferentially adjacent an outer edge(s) of the rotor blade(s) 15. An (outer) stator shroud member 99 is/are provided adjacent outer edges of the stator blade(s) 20.

In one implementation the rotor shroud 98 may be stationary, while in another the rotor shroud 98 may rotate with the rotor blade(s) 15 and rotor hub 60. In one implementation the rotor shroud 98 may be formed separately from the rotor blade(s) 15 and rotor hub 60. In such case there may be a gap between the rotor shroud 98 and tip(s) of the rotor blade(s) 15, e.g. so as to allow rotation of the outer hub. In another implementation the rotor shroud 98 may be formed integrally with or joined with the rotor blade(s) 15 and rotor hub 60. In one implementation the stator shroud 99 may be formed separately from stator blade(s) 20 and stator hub 65. In another implementation the stator shroud 99 may be formed integrally with or joined with the stator blade(s) 20 and stator hub 65.

The rotor 25 and stator 30 can be constructed in the same manner, e.g.

a) the hub 60, 65, blades 15, 20 and shroud 98, 99 can be produced as a single piece (by 3D printing, for example), or

b) the hub 60, 65 and blades 15, 20 can be machined/cast as one piece and the shroud added as a separate piece, or

c) the hub 60, 65, blades 15, 20 and shroud 98, 99 can be made separately and brazed or otherwise bonded together.

The turbine 5 is a fluid driven turbine, and the aforementioned fluid comprises the turbine drive fluid.

As can be seen from FIG. 1(b), the turbine 5 comprises a plurality of (stacked) stator and rotor pairs. The stator and rotor stack has a stator 30 furthest uphole, i.e. closest to surface, than the rotor 25 of that pair.

Beneficially for each stator/rotor pair, the number of rotor blades 15 is less than the number of stator blades 20.

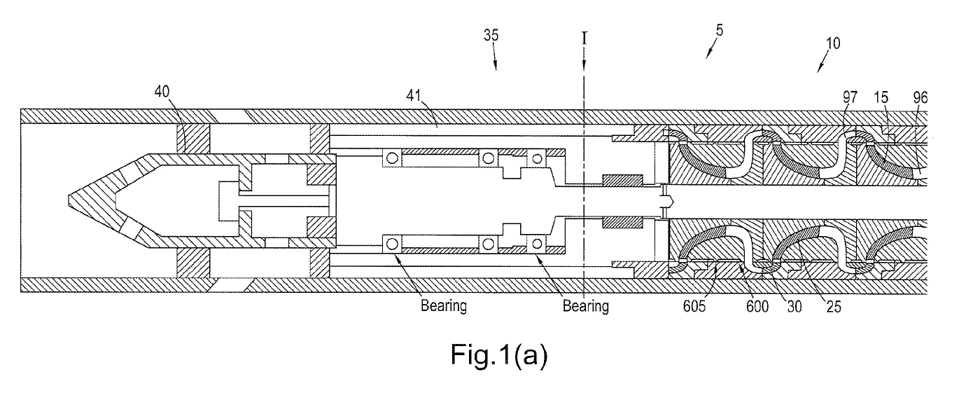

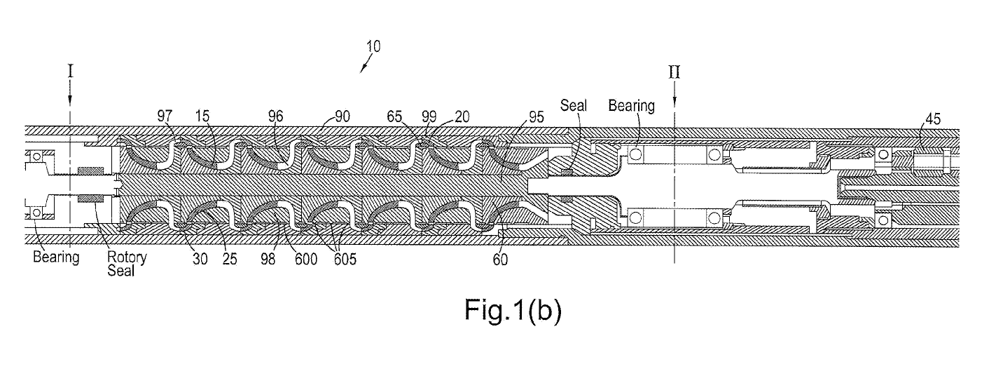

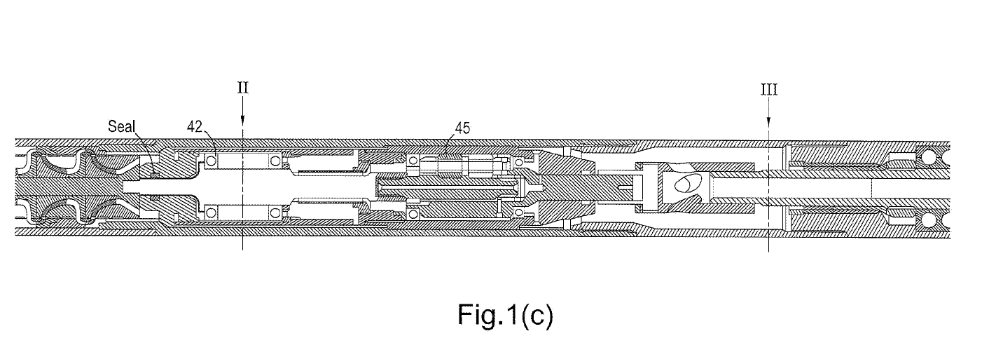

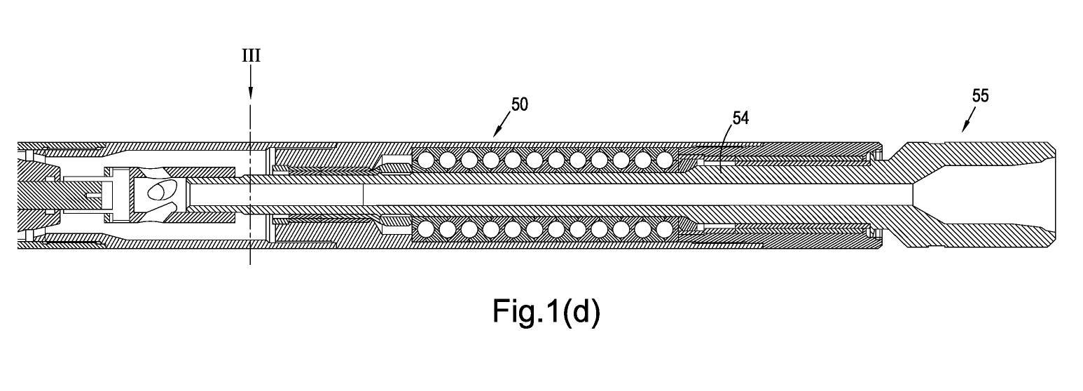

Referring to FIGS. 2 and 3, in this embodiment each rotor 25 comprises a plurality of circumferentially disposed rotor blades, i.e. 14 rotor blades 15.

Further, in this embodiment each stator 30 comprises a plurality of stator blades, i.e. 19 stator blades 20.

It will, however, be appreciated that in modifications to this embodiment each rotor 25 can typically comprise between 8 and 16 rotor blades, and beneficially 12 or 14 rotor blades, and each stator 30 can typically comprise between 14 and 24 stator blades, and beneficially 17 or 19 stator blades.

In use, the turbine assembly 35 can be used in a method of drilling a borehole, such as an oil or gas well, as follows. The method of drilling the borehole comprises:

providing a drill string comprising a turbine 5 assembly comprising a turbine according to the present invention;

drilling the borehole.

The drill string provides the drill bit 55 at a downhole/downstream end thereof. Drilling the borehole comprises (rotationally) driving the bit box 55 by the turbine 5 by providing turbine drive fluid to the turbine 5 so as to rotate the rotors 25, shaft 95 and bit box 55.

The turbine 5 of the present invention addresses at least one problem in the prior art by diverting a fluid flow radially as well as circumferentially in both the rotor and stator stages. The resulting radius change allows for greater changes in angular momentum, and thus greater torque production per turbine stage. For a given performance therefore, the turbine of the present invention is shorter, and consists of few parts or stages.

As each stage is more highly loaded, the runaway speed of the turbine 5 is significantly higher than the design load speed. Therefore, a speed-activated bypass valve/governor 40 is used in conjunction to limit the maximum turbine speed.

The drive fluid enters the turbine 5 in an axial direction. The fluid encounters the first stator stage, which incorporates three dimensional blading which forms blade passages which turn the fluid from an axial direction to a radially inwards direction (towards a centre of the turbine) and simultaneously turns the fluid circumferentially, imparting an angular momentum to the fluid. The fluid then enters a rotor stage, where a rotor passage turns the flow from a radial direction back to an axial direction. Blading in a rotor passage removes and converts circumferential motion of the fluid into torque on the rotor shaft. The fluid thus leaves the rotor blades in an axial direction with little or no circumferential motion.

The rotor exit passage turns the fluid from the axial direction to a radially outward direction where the fluid is presented to the next stator stage.

Other than the first stator stage, in which the fluid enters the stator in an axial direction, the fluid enters subsequent stator stages in a radially outward direction from the previous rotor stage. The stator passage turns the fluid from a radially outward direction to an axial direction, before encountering the stator blades, and the fluid is again turned from an axial direction to a radially inward direction and simultaneously turned circumferentially.

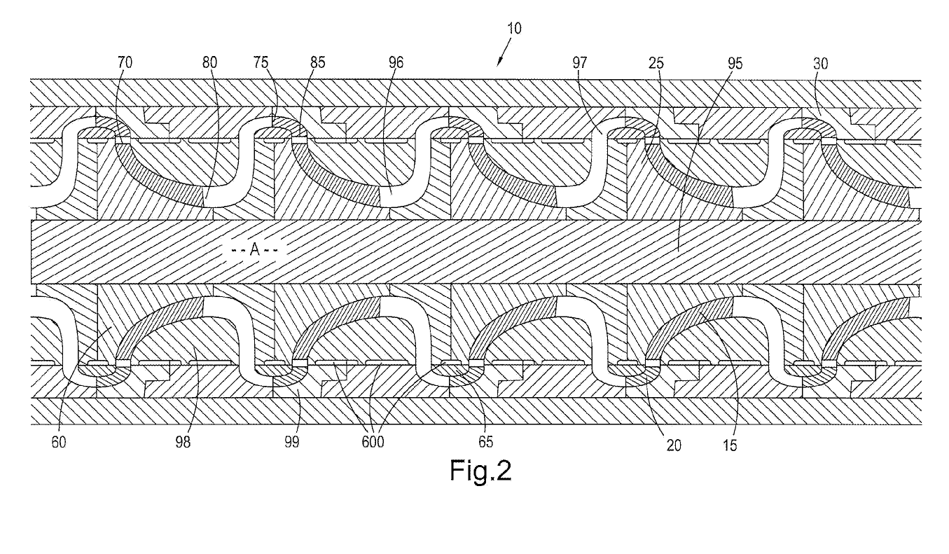

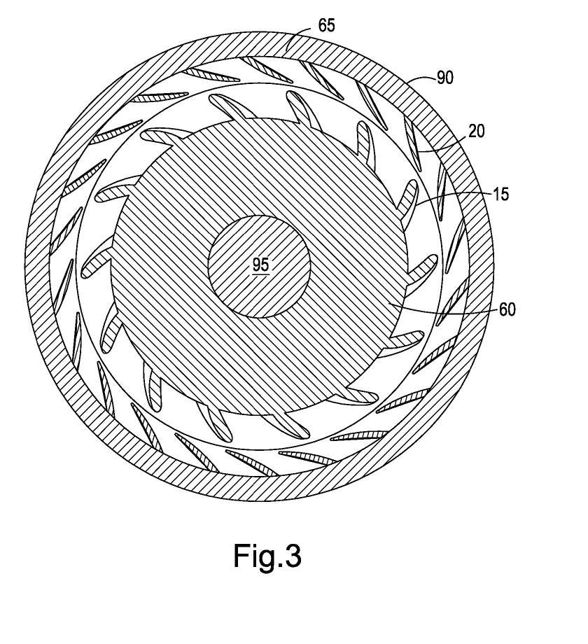

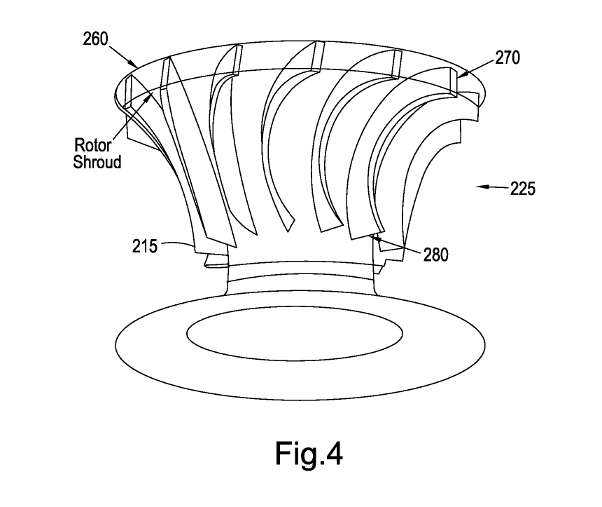

Referring now to FIGS. 4 to 5(b), there is shown a second rotor, generally designated 225, suitable for use in the turbine 5. The/each rotor 225 comprises a plurality of circumferentially disposed rotor blades 215 provided on a rotor hub 260.

The number of rotor blades 215 is between 8 and 16 blades, and in this embodiment 11 or 13 blades.

Beneficially for the/each rotor blade 215:

a leading edge angle from a radial direction at a leading edge hub is between 25° and 50°, e.g. 35°; and

a leading edge angle from a radial direction at a leading edge shroud is between 30 and 55°, e.g. 48°; and

a trailing edge angle from an axial direction at a trailing edge hub is between −21° and −29°, e.g. −25°; and

a trailing edge angle from an axial direction at a trailing edge shroud is between −20° and −50°, e.g. −45°.

Beneficially for the/each rotor blade 215:

the rotor blade thickness at a leading edge 270 is between 2 mm and 8 mm, e.g. 3 mm, 4 mm or 5 mm; and/or

the rotor blade thickness at a trailing edge 280 is between 0.25 mm and 2 mm, e.g. 0.5 mm, 1 mm or 1.5 mm.

Referring now to FIG. 6, there is shown a second stator 230 suitable for use in the turbine 5. The/each stator 230 comprises a plurality of circumferentially disposed stator blades 220 provided on a stator hub 265. The number of stator blades 220 is between 14 and 24 in this embodiment 17 or 21 or 19.

Beneficially for the/each stator blade 220:

a leading edge angle from an axial direction at a leading edge hub and/or leading edge shroud is between −5° and 5°, e.g. 0°; and

a trailing edge angle from a radial direction at a trailing edge hub and/or trailing edge shroud is between 65° and 80°, e.g. 75° or 70° or 69°.

Beneficially for the/each stator blade:

the stator blade thickness at a leading edge 275 is between 3 mm and 5 mm, e.g. 4 mm; and

the stator blade thickness at a trailing edge 276 is between 0.5 mm and 2 mm, e.g. 1 mm.

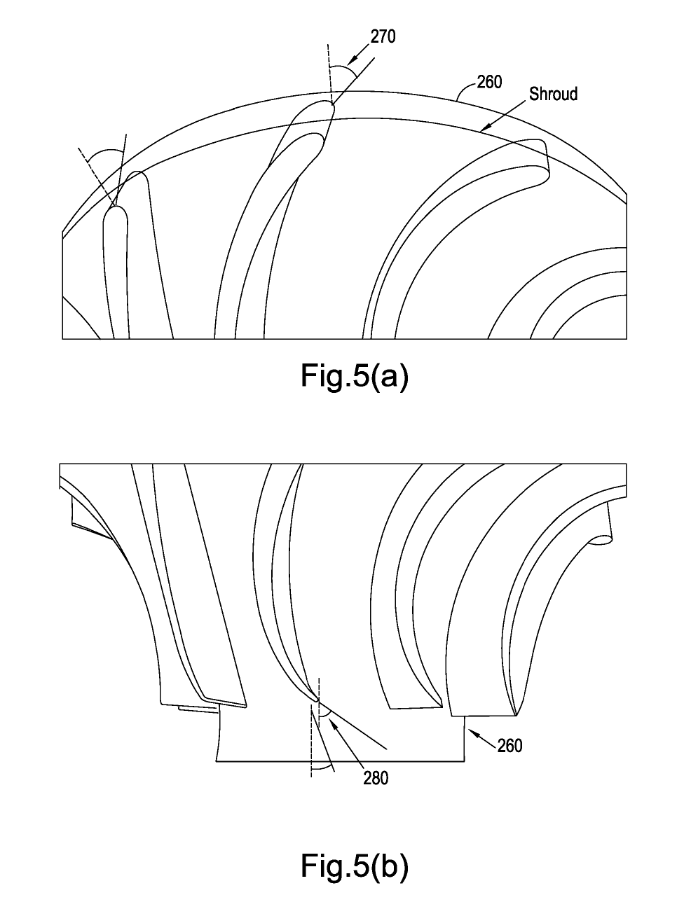

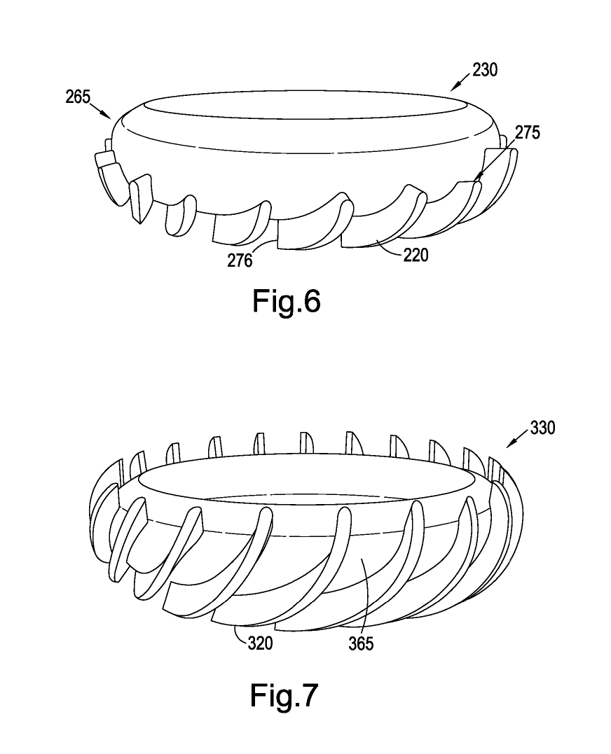

Referring now to FIG. 7, there is shown a third stator 330 suitable for use in the turbine 5. In the stator 330, the stator blades 320 extend all the way to a stator inlet, in which case, in use, the fluid begins to be turned circumferentially simultaneously with the passage turning the flow from radially outward to axial. In this case the stator blade leading edge angles would be 0° to the radial, instead of 0° from the axial.

Referring now to FIGS. 8(a) and (b), there is shown a fourth stator 430, suitable for use in the turbine 5.

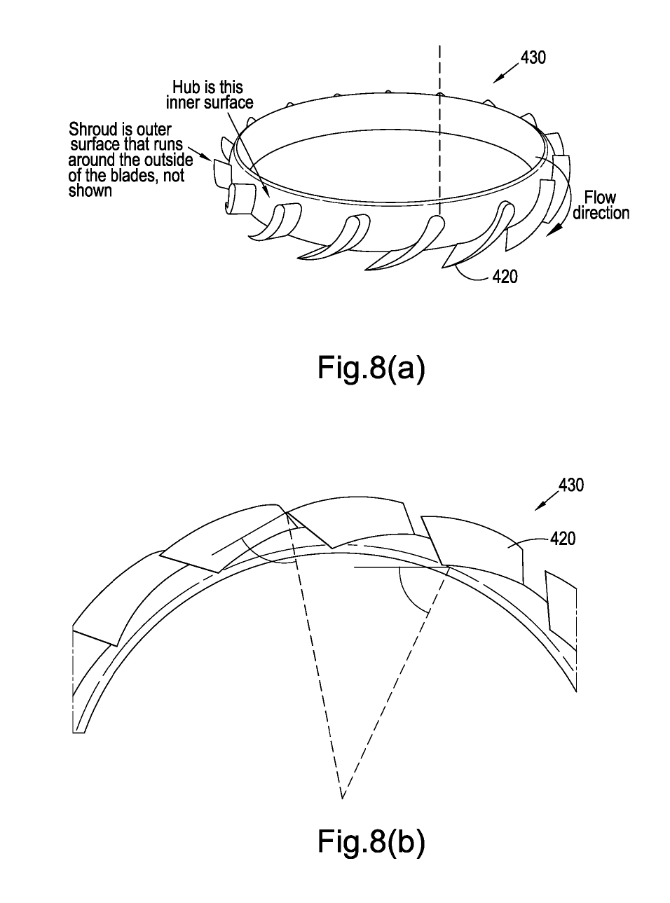

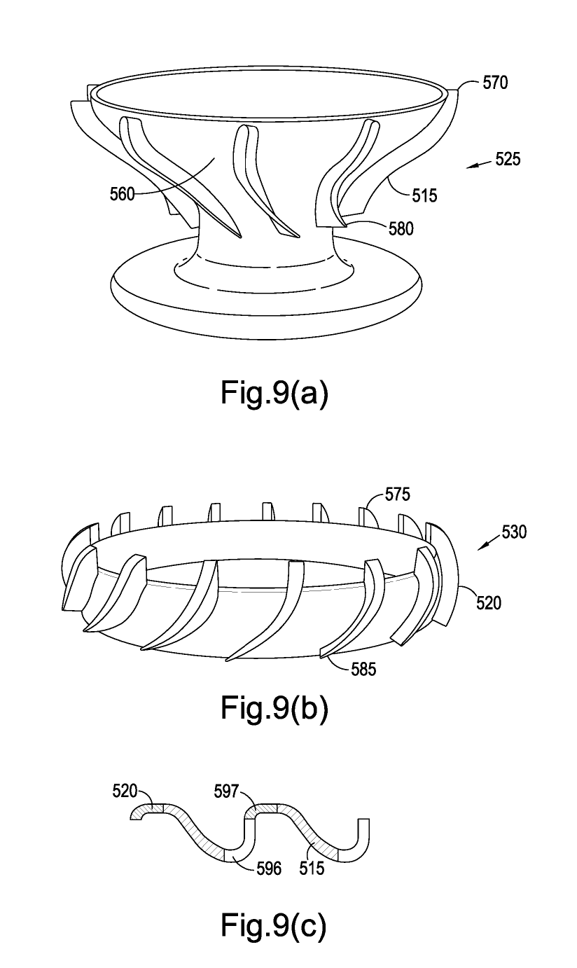

Referring now to FIGS. 9(a) to (c), there is shown a further stator 530, suitable for use in the turbine 5. In this modification the turbine 5 comprises at least one rotor 525 wherein the at least one rotor 525 comprises at least one rotor blade 515 to form at least one blade passage arranged or configured to impart radial motion to a turbine drive fluid, in use.

A leading or first portion of the at least one rotor blade (passage) 515 is arranged or configured to convert a/the motion of the turbine drive fluid from a substantially or at least part axial (e.g. axial and circumferential) motion to a substantially or at least part radial, such as radially inward (e.g. radial and circumferential) motion.

The substantially radial motion is radial inward motion.

A trailing or second portion of the at least one rotor blade (passage) 515 is arranged or configured to cause the turbine drive fluid to leave or exit the at least one rotor blade 515 with a substantially or at least part radial motion.

Also in this modification the turbine 5 comprises at least one stator 530 wherein the at least one stator 530 comprises at least one stator blade 520 to form at least one blade passage arranged or configured to impart axial and circumferential motion to a turbine drive fluid, in use.

The at least one stator blade (passage) 520 is arranged or configured to convert a/the motion of the turbine drive fluid from a substantially or at least part radial, such as radially outward (e.g. radially and circumferential) motion to a substantially or at least part axial (e.g. axial and circumferential) motion.

Thus in this arrangement, the stator 530 has an axial output rather than a radial output, and the rotor 525 performs the turning of the fluid from axial to radial.

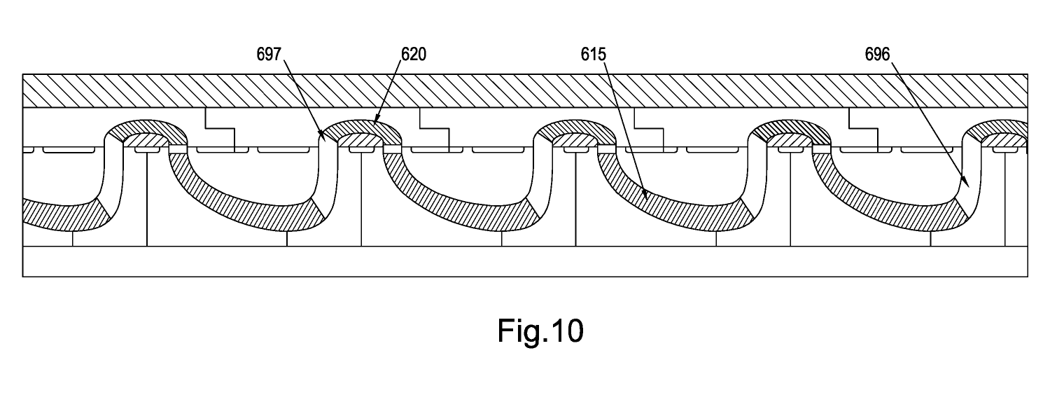

Referring to FIG. 10, there is shown a further arrangement of the downhole turbine 5. In this modification the turbine 5 comprises at least one rotor 625 wherein the at least one rotor 625 comprises at least one rotor blade 615 to form at least one blade passage arranged or configured to impart radial motion to a turbine drive fluid, in use.

A leading or first portion of the at least one rotor blade (passage) 615 is arranged or configured to convert a/the motion of the turbine drive fluid from a substantially radial such as radially inward, (e.g. radial and circumferential) motion to a substantially or at least part axial (e.g. axial and circumferential) motion.

The substantially radial motion is a radial inward motion.

A trailing or second portion of the at least one rotor blade (passage) 615 is arranged or configured to convert a/the motion of the turbine drive fluid from a substantially or at least part axial (e.g. axial and circumferential) motion to a substantially radial, such as radially outward, (e.g. radial and circumferential) motion.

Also in this modification the turbine 5 comprises at least one stator 630 wherein the at least one stator comprises at least one stator blade 620 to form at least one blade passage arranged or configured to impart radial motion to a turbine drive fluid, in use.

The at least one stator blade 620 is arranged or configured to convert a/the motion of the turbine drive fluid from a substantially radial (e.g. radially outward; radial and circumferential) motion to a substantially radial (e.g. radially inward; radial and circumferential) motion.

A leading or first portion of the at least one stator blade (passage) 620 is arranged or configured to convert a/the motion of the turbine drive fluid from a substantially radial such as radially outward, (e.g. radial and circumferential) motion to a substantially or at least part axial (e.g. axial and circumferential) motion.

The substantially radial motion is a radial outward motion.

A trailing or second portion of the at least one stator blade (passage) 620 is arranged or configured to convert a/the motion of the turbine drive fluid from a substantially or at least part axial (e.g. axial and circumferential) motion to a substantially radial, such as radially inward, (e.g. radial and circumferential) motion.

A rotor exit passage 696 is configured to cause the turbine drive fluid to be moved or diverted substantially radially (e.g. radially outward). In this embodiment the rotor exit passage 696 is substantially annular or ring shaped

A stator inlet passage 697 is configured to cause the turbine drive fluid to be moved or diverted, e.g. moved or diverted, substantially radially (e.g. radially outwards) and/or substantially or at least partially axially. In this embodiment the stator exit passage 697 is substantially annular or ring shaped.

As can be seen in FIG. 10, the stator blade 620 extends towards the stator inlet passage 697, in which case, in use the fluid begins to be turned circumferentially simultaneously with the passage turning the flow from substantially or at least part radially outwards to substantially or at least part radially inwards. In this modification the rotor blade 615 extends towards the rotor outlet/rotor exit passage 696.

The drive fluid enters the turbine 5 in an axial direction. The fluid encounters the first stator stage 630, which incorporates three dimensional blading which forms blade passages 620 which turn the fluid from a radially outward direction to a radially inwards direction (towards a centre of the turbine) and simultaneously turns the fluid circumferentially, imparting an angular momentum to the fluid. When entering the stator blade 620 the fluid moves radially outwards. The stator blade 620 includes an axial component, which guides the fluid in an axial direction, prior to diverting the fluid radially inwards.

The fluid then enters a rotor stage 625, where a rotor passage 615 turns the flow from a radial direction back to a substantially or at least part axial direction. Blading in a rotor passage 615 removes and converts circumferential motion of the fluid into torque on the rotor shaft. The fluid leaves the rotor blades 615 in a substantially or at least part radially outwards direction with little or no circumferential motion. The rotor blade 615 includes a substantially or at least part axial component, which guides the fluid in an axial direction, prior to diverting the fluid radially outwards.

The rotor exit passage 696 moves the fluid further to a radially outward direction where the fluid is presented to the next stator stage.

The fluid enters subsequent stator stages in a radially outward direction from the previous rotor stage. The stator passage inlet 697 moves the fluid further in a radially outward direction, before encountering the stator blades 620, and the fluid is turned from a radially outward direction to a substantially axial direction and subsequently to a radially inward direction and simultaneously turned circumferentially.

In the embodiments disclosed hereinbefore the rotor(s) (25, 225, 525, 625) and/or the stator(s) (30,230,330,430,530, 630) can be made from or comprise a ceramic material, e.g. Tungsten Carbide. Such rotor(s)/stator(s) can be made by a machining technique. In such implementation the rotor has a leading edge (LE), angle of 30° at both hub and shroud, and trailing edge (TE), angle of −20° at both hub and shroud. It will be noted that this version has 12 rotor blades and 17 stator blades.

Alternatively in the embodiments disclosed hereinbefore the rotor(s) (14, 225, 525, 625) and/or the stator(s) (30, 230, 330, 430, 530, 630) can be made from a metallic material, e.g. Cobalt Chrome or Inconel. Such rotor(s)/stator(s) can be made by a printing/casting technique. In such an implementation the rotor has LE angles of 35° at hub and 48° at shroud, and TE angles of 25° at hub and −45° at shroud. It will be noted that in this version has 14 rotor blades and 19 stator blades.

Referring to FIGS. 1(a) to 2, the turbine 5, wherein there is provided at least one chamber 600 between at least a portion of at least one rotor 25 and at least a portion of an at least one stator 30.

The at least one chamber 600 may comprise a plurality of chambers.

Each chamber 600 is at least partially circumferentially extending around the turbine 5. The plurality of chambers 600 are substantially longitudinally spaced one from the other.

The at least a portion of the/each at least one rotor 25 comprises at least one/a respective rotor shroud 98.

The at least a portion of the/each at least one stator 30 comprises at least one/a respective stator hub 65 and/or at least one/a respective stator shroud 99.

The at least one/each chamber 600, in use, acts as a vibration damping chamber. At a/each longitudinal end of the/each chamber 600 is provided with a seal 605, e.g. a liquid seal. The/each seal 605, in use, acts as a vibration damping chamber seal. A seal 605 is provided between adjacent chambers 600.

To prevent leakage of drive fluid/hydraulic fluid between an outer diameter of a rotor 25 and an internal diameter of a stator 30, it is preferable to have a very small gap between the rotor 25 and the stator 30, typically 0.1 mm to 0.2 mm in radius. In order to reduce the extent of possible contact between rotor 25 and stator 30, annular depressions are formed around the outer diameter of the rotor 25, leaving seals 605 or seal areas at the full rotor diameter at the beginning and end of each depression. The seal areas are typically between 10% and 25% of the length of the depression.

This arrangement of sealing areas and depressions, forms fluid filled vibration dampening chambers 600 that trap fluid and act to dampen radial movement of the rotor 25 with respect of the stator 30. The depth radial extent of the vibration dampening chambers may be between 2 mm to 4 mm. The arrangement of small gaps combined with the sudden expansions and contractions that the fluid encounters as it flows through the chambers 600 also acts as a leaking seal, restricting the leakage of fluid which tries to bypass the rotors 25 and stators 30 from state to stage without doing useful work.

It will be appreciated that the embodiments of the present invention hereinbefore described are given by way of example only, and are not intended to be limiting to the scope of the invention. The skilled person will appreciate that various modifications may be made to the disclosed embodiments within the scope of the invention.

It will be appreciated that a turbine of the present invention may typically comprise fewer stages than a turbine of the prior art. For example, a turbine of the present invention may provide around 5 to 9 stages, as compared with 30 or so stages of turbines of the prior art.

1.-105. (canceled)

106. A turbine or motor, such as a downhole turbine or motor, wherein there is provided a fluid passage comprising at least one portion or zone arranged to cause a drive fluid to be moved or diverted, such as at least partly radially.

107. A turbine or motor, such as a downhole turbine or motor, as claimed in claim 106, wherein the turbine comprises at least one of:
a rotor comprising at least one of:
at least one rotor blade extending within the fluid passage;
a plurality of circumferentially disposed rotor blades; and
a hub which carries the at least one rotor blade;
peripherally/circumferentially thereupon;
a stator comprising at least one of:
at least one stator blade extending within the fluid passage;
a plurality of circumferentially disposed stator blades;
a stator hub which carries the at least one stator blade;
peripherally/circumferentially thereupon; and
a tubular housing, the stator being mounted in fixed relation to the tubular housing; and
a rotatable shaft, the rotor being mounted in fixed relation to the shaft.

108. A turbine or motor, such as a downhole turbine or motor, as claimed in claim 107, wherein the stator comprises or defines at least part of the at least one portion or zone configured or arranged to cause the fluid to be moved in or diverted from an at least part axial path to an at least part radial path or radially inward path.

109. A turbine or motor, such as a downhole turbine or motor, as claimed in claim 107, wherein the rotor comprises or defines at least part of the at least one portion or zone configured or arranged to cause the fluid to be moved in or diverted from an at least part radial path or radially inward path to an at least part axial path.

110. A turbine or motor, such as a downhole turbine or motor, as claimed in claim 106, wherein the diverted path or such at least part radial movement or diversion causes a change, such as an increased or greater change, in the angular momentum of the fluid.

111. A turbine or motor, such as a downhole turbine or motor, as claimed in claim 106, wherein angular momentum of the fluid is transferred to the turbine or rotor(s) of the turbine or rotor blade(s) of the turbine, thus generating torque.

112. A turbine or motor, such as a downhole turbine or motor, as claimed in claim 106, wherein at least one of:
a diverted path of the fluid comprises a radial part and a circumferential part; and
a path prior to diversion comprises an axial part and a circumferential part.

113. A turbine or motor, such as a downhole turbine or motor, as claimed in claim 107, wherein at least one of:
the radial movement or diversion is radially inward; and
the radial movement or diversion occurs over a portion of the at least one blade of a stator and/or rotor of the turbine.

114. A turbine or motor, such as a downhole turbine or motor, as claimed in claim 107, wherein the/each rotor is arranged so as to transfer energy of radial motion or radially inward motion of the fluid to an output means of the turbine.

115. A turbine, such as a downhole turbine, as claimed in claim 107, wherein the at least one rotor/stator blade comprises a fluid inlet end and a fluid outlet end, the fluid inlet end being disposed radially outward and axially upstream of the fluid outlet end and the outlet end of the stator being in fluid communication with the inlet end of the rotor.

116. A turbine or motor, such as a downhole turbine or motor, as claimed in claim 107, wherein there is provided at least one of:
at least one chamber between at least a portion of at least one rotor;
and at least a portion of an at least one stator;
at least one chamber between at least a portion of at least one rotor;
and at least a portion of an at least one stator, the at least one chamber, in use, acting as a vibration damping chamber;
at least one chamber between at least a portion of at least one rotor and at least a portion of an at least one stator, at a longitudinal end of the chamber is provided a seal, such as a liquid seal;
at least one chamber between at least a portion of at least one rotor and at least a portion of an at least one stator, the at least a portion of the/each at least one rotor comprising at least one/a respective rotor shroud; and
at least one chamber between at least a portion of at least one rotor and at least a portion of an at least one stator, the at least a portion of the/each at least one stator comprising at least one/respective stator hub and/or at least one/a respective stator shroud.

117. A turbine or motor, such as a downhole turbine or motor, as claimed in claim 107, wherein there is provided at least one of:
a plurality of chambers between at least a portion of at least one rotor and at least a portion of an at least one stator;
a plurality of chambers between at least a portion of at least one rotor and at least a portion of an at least one stator, each chamber being at least partially circumferentially extending around the turbine or motor;
a plurality of chambers between at least a portion of at least one rotor and at least a portion of an at least one stator, the plurality of chambers are substantially longitudinal spaced one from the other;
a plurality of chambers between at least a portion of at least one rotor and at least a portion of an at least one stator, each chamber, in use, acting as a vibration damping chamber;
a plurality of chambers between at least a portion of at least one rotor and at least a portion of an at least one stator, at each longitudinal end of each chamber being provided a seal, such as a liquid seal;
a plurality of chambers between at least a portion of at least one rotor and at least a portion of an at least one stator, a seal being provided between adjacent chambers;
a plurality of chambers between at least a portion of at least one rotor and at least a portion of an at least one stator, the at least a portion of the/each at least one rotor comprising at least one/a respective rotor shroud; and
a plurality of chambers between at least a portion of at least one rotor and at least a portion of an at least one stator, the at least a portion of the/each at least one stator comprising at least one/respective stator hub and/or at least one/a respective stator shroud.

118. A turbine or motor, such as a downhole turbine or motor, as claimed in claim 106, wherein the turbine comprises a plurality of stages, each stage comprising or longitudinally comprising a/the stator, a/the rotor, a passage, such as a rotor passage and a stator passage, each of which are in fluid communication with one another and wherein a passage or stator passage of one stage is adjacent and is in fluid communication with a rotor passage of a next stage.

119. A turbine or motor, such as a downhole turbine or motor, as claimed in claim 107, wherein an (outer) rotor shroud is provided (circumferentially) adjacent an outer edge(s) of rotor blade(s) of a/each rotor, the rotor shroud being stationary or the rotor shroud rotating with the rotor blade(s) and rotor hub.

120. A turbine or motor, such as a downhole turbine or motor, as claimed in claim 107, wherein an (outer) stator shroud is provided (circumferentially) adjacent an outer edge(s) of stator blade(s) of a/each stator, the stator shroud being formed separately from stator blade(s) and stator hub, or the stator shroud being formed integrally with or joined with the stator blade(s) and stator hub.

121. A turbine or motor, such as a downhole turbine or motor, as claimed in claim 107, wherein the/each rotor is arranged so as to rotate with an output means such as output shaft of the turbine, the each rotor being keyed to the output shaft.

122. A turbine or motor, such as a downhole turbine or motor, as claimed in claim 106, wherein the fluid passage comprises at least one of:
at least one further portion or zone arranged to cause a/the fluid to be further diverted radially;
at least one further portion or zone arranged to cause a/the fluid to be further diverted radially outward; and
at least one further portion or zone arranged to cause a/the fluid to be further diverted radially, the further radial diversion occurring over a portion of a/the passage or rotor passage.

123. A turbine or motor, such as a downhole turbine or motor, as claimed in claim 107, wherein the at least one rotor/stator blade comprises a leading (upstream) edge and a trailing (downstream) edge, the leading edge being disposed radially outward of the trailing edge.

124. A turbine or motor, such as a downhole turbine or turbine, as claimed in claim 107, wherein the rotor comprises at least one of at least one rotor blade arranged or configured to impart axial motion to a turbine drive fluid, in use;
at least one rotor blade forming at least one rotor blade passage arranged or configured to impart axial motion to a turbine drive fluid, in use; and
at least one rotor blade forming at least one rotor blade passage arranged or configured to convert a motion of the drive fluid from a substantially radial motion to a substantially axial motion.

125. A turbine, such as a downhole turbine, as claimed in claim 124, wherein the at least one rotor blade and/or rotor blade passage comprises at least one of:
a leading or first portion arranged or configured to convert a/the motion of the turbine drive fluid from a substantially radial, such as radially inward (such as radial and circumferential) motion to a substantially axial (such as axial and circumferential) motion; and
a trailing or second portion arranged or configured to cause the turbine drive fluid to leave or exit (or alternatively arrive or enter) the at least one blade with a substantially axial motion.

126. A turbine or motor, such as a downhole turbine or motor, as claimed in claim 107, wherein the stator comprises at least one of:
at least one stator blade arranged or configured to impart radial motion to a turbine drive fluid, in use;
at least one stator blade forming at least one stator blade passage arranged or configured to impart radial motion to a turbine drive fluid, in use; and
at least one stator blade and/or stator blade passage arranged or configured to convert a/the motion of the turbine drive fluid from a substantially axial (such as axial and circumferential) motion to a substantially radial, such as radially inward (such as radial and circumferential) motion.

127. A turbine or motor, such as a downhole turbine or motor, as claimed in claim 107, wherein the at least one rotor comprises at least one of:
at least one rotor blade arranged or configured to impart radial motion to a turbine drive fluid, in use; and
at least one rotor blade forms at least one rotor blade passage arranged or configured to impart radial motion to a turbine drive fluid, in use.

128. A turbine or motor, such as a downhole turbine or motor, as claimed in claim 127, wherein the at least one rotor blade and/or rotor blade passage comprises at least one of:
a leading or first portion of the arranged or configured to convert a/the motion of the turbine drive fluid from a substantially axial, (such as axial and circumferential motion) to a substantially radial, such as radially inward (such as radial and circumferential) motion; and
a trailing or second portion arranged or configured to cause the turbine drive fluid to leave or exit the at least one blade with a substantially radial motion.

129. A turbine or motor, such as a downhole turbine or motor, as claimed in claim 107, wherein the at least one stator comprises at least one of:
at least one stator blade arranged or configured to impart axial motion to a turbine drive fluid, in use;
at least one stator blade forming at least one stator blade passage arranged or configured to impart axial and circumferential motion to a turbine drive fluid, in use.

130. A turbine or motor, such as a downhole turbine or motor, as claimed in claim 129, wherein the at least one stator blade and/or stator blade passage is arranged or configured to convert a/the motion of the turbine drive fluid from a substantially radial, such as radially outward, such as radial and circumferential motion, to a substantially axial, such as axial and circumferential motion.

131. A turbine or motor, such as a downhole turbine or motor, as claimed in claim 127, wherein at least one rotor blade and/or rotor blade passage comprises at least one of:
a leading or first portion of the arranged or configured to convert a/the motion of the turbine drive fluid from a substantially or at least part radial such as radially inward, such as radial and circumferential, motion to a substantially or at least part axial, such as axial and circumferential motion; and
a trailing or second portion arranged or configured to convert a/the motion of the turbine drive fluid from a substantially or at least part axial, such as axial and circumferential, motion to an at least part radial, such as radially outward, such as radial and circumferential, motion.

132. A turbine or motor, such as a downhole turbine or motor, as claimed in claim 126, wherein the at least one stator blade and/or stator blade passage is arranged or configured to convert a/the motion of the turbine drive fluid from a substantially or at least part radial, such as radially outward, such as radial and circumferential, motion to a substantially radial, such as radially inward, such as radial and circumferential motion.

133. A turbine or motor, such as a downhole turbine or motor, as claimed in claim 132, wherein the at least one stator blade and/or stator blade passage comprises at least one of:
a leading or first portion of arranged or configured to convert a/the motion of the turbine drive fluid from a substantially or at least part radial such as radially outward, such as radial and circumferential, motion to a substantially or at least part axial, such as axial and circumferential, motion; and
a trailing or second portion arranged or configured to convert a/the motion of the turbine drive fluid from a substantially or at least part axial, such axial and circumferential, motion to a substantially or at least part radial, such as radially inward, such as radial and circumferential, motion.

134. A turbine or motor, such as a downhole turbine or motor, as claimed in claim 106, wherein the turbine comprises at least one of:
a rotor exit passage causing the motion of turbine drive fluid to convert from the substantially axial motion or part radial motion to a substantially radial such as radially outward motion; and
a stator inlet passage causing the motion of turbine drive fluid to convert from a radial (such as radially outward) motion to a substantially axial (such as axial and circumferential) motion.

135. A turbine or motor, such as a downhole turbine or motor, as claimed in claim 107, wherein for the/each rotor blade at least one of:
a leading edge (LE) angle from a radial direction at the leading edge hub is between 25° and 50°, or is 35°;
a leading edge angle from a radial direction at the leading edge shroud is between 40° and 55°, or is 48°; a trailing edge (TE) angle from an axial direction at the trailing edge hub is between −20° and −29°, or is −25°; a trailing edge angle from an axial direction at the trailing edge shroud is between −20° and −50°, or is −45°;
a rotor blade thickness at the leading edge is between 2 mm and 8 mm, or is 3 mm or 5 mm; and
a rotor blade thickness at the trailing edge is between 0.25 mm and 2 mm, or is 1 mm or 1.5 mm.

136. A turbine or motor, such as a downhole turbine or motor, as claimed in claim 107, wherein for the/each stator blade at least one of:
a leading edge angle from an axial direction at the leading edge hub and/or leading edge shroud is between −5° and 5°, or is 0°;
a trailing edge angle from a radial direction at the trailing edge hub and/or trailing edge shroud is between 65° and 80°, or is 70° or 69°;
a stator blade thickness at the leading edge is between 3 mm and 5 mm, or is 4 mm; and
a stator blade thickness at the trailing edge is between 0.5 mm and 2 mm, or is 1 mm.

137. A turbine or motor, such as a downhole turbine or motor, as claimed in claim 107, wherein the turbine comprises at least one of:
a power section comprising the at least one stator/rotor blade; and
a power section comprising at least one rotor and/or stator.

138. A turbine assembly comprising a turbine according to claim 106.

139. A turbine assembly as claimed in claim 138, wherein the turbine assembly comprises one or more of:
a governor, optionally above the turbine or power section;
an upper bearing means or pack, optionally between the governor and the turbine or power section;
a lower bearing means or pack, optionally below the turbine or power section;
a gear mechanism, optionally below the turbine or power section;
a further lower bearing means or pack, optionally below the gear mechanism; and/or
a bit box, below the lower bearing means or pack.

140. A method of drilling a borehole, such as an oil or gas well, the method comprising:
providing a drill string comprising a turbine, wherein there is provided a fluid passage comprising at least one portion or zone arranged to cause a drive fluid to be moved or diverted, such as at least partly radially;
drilling the borehole;
the drill string provides a drill bit, such as at a downhole/downstream end thereof; and
drilling the borehole comprises (rotationally) driving the drill bit by the turbine.

141. A turbine or motor, such as a downhole turbine or motor, as claimed in claim 107, wherein the rotor and/or stator is/are at least one of:
at least partly made from or (substantially) comprises a ceramic material;
substantially made from or substantially comprises Tungsten Carbide; and
manufactured by a machining technique.

142. A rotor and/or stator when used in a turbine or motor, such as a downhole turbine or motor according to claim 106.
